(19) United States
(12) Patent Application Publication
(10) Pub. No.: US 2007/0125664 A1
(43) Pub. Date: Jun. 7, 2007

(54) Gas sensor element and methods of making and using the same

(76) Inventors: William J. LaBarge, Bay City, MI (US); Joachim Kupe, Davisburg, MI (US); Walter T. Symons, Grand Blanc, MI (US)

Correspondence Address: Paul L. Marshall;Delphi Technologies, Inc., M/C 480-410-202, P.O. Box 5052, Troy, MI, 48007, US

(21) Appl. No.: 11/295,030

(22) Filed: Dec. 5, 2005

(51) Int. Cl. G01F 1/64; G01N 27/26

(52) U.S. Cl. 205/780.5; 204/424

(57) ABSTRACT

In one embodiment, a gas sensor element comprises: an electrolyte disposed between and in ionic communication with a first electrode and a second electrode; and a protective layer disposed adjacent to the first electrode. The protective layer comprises a catalytic coating comprising a reducible support material, a catalyst, and a water activator material. The catalyst coating is capable of converting an oxygen consuming species in a gas to an oxygen donating species.

### BACKGROUND

Exhaust sensors have been used for many years in automotive vehicles to sense the presence of exhaust gases. In automotive applications, the direct relationship between various exhaust gas concentrations and the air-to-fuel ratio of the fuel mixture supplied to the engine allows the sensor to provide concentration measurements for determination of optimum combustion conditions, maximization of fuel economy, and the management of exhaust emissions. More particularly, with regard nitrogen oxides (e.g., NO₂+NO+N₂O+NH₃), hereinafter referred to as NOx, it is noted that there are several different methods to detect NOₓ in exhaust gas, which include thermal, optical, electronic resistive, and electrochemical methods.

Electrochemical methods of detecting NOx have proven to be particularly effective because the sensor materials are compatible with the high temperature environment (e.g., greater than or equal to 500° C.) created by the exhaust gas. With the electrochemical method, there are two basic principles involved in NOx sensing, i.e., the Nernst principle and the polarographic principle.

With the Nernst principle, chemical energy is converted into an electromotive force (emf) that can be measured to estimate the amount of NOx in the exhaust stream. A gas sensor based upon this principle can include an ionically conductive solid electrolyte material, a porous electrode with a porous protective overcoat exposed to exhaust gases (“exhaust gas electrode”), and a porous electrode exposed to a known gas partial pressure (“reference electrode”). Sensors used in automotive applications may use a yttrium stabilized zirconia based electrochemical galvanic cell with porous platinum electrodes, operating in potentiometric mode, to detect the relative amounts of a particular gas, such as oxygen for example, that is present in an exhaust from an automobile engine. When opposite surfaces of the galvanic cell are exposed to different oxygen partial pressures, the electromotive force is developed between the electrodes on the opposite surfaces of the zirconia wall, according to the Nernst equation:

$$E = ( \frac{RT}{4 F} ) ln ( \frac{{P}_{{O}_{2}}^{ref}}{{P}_{{O}_{2}}} )$$

where:
E=electromotive force
R=universal gas constant
F=Faraday constant
T=absolute temperature of the gas
P_{O}_{₂}^{ref}=oxygen partial pressure of the reference gas
P_{O}_{₂}=oxygen partial pressure of the exhaust gas
   The current produced from the electromotive force can be measured to estimate the NOx concentration within the exhaust stream.

Gas sensors that employ the polarographic principle utilize electrolysis (i.e., measuring the current employed to decompose a gas, such as NO_{X}) to determine the concentration of a gas within the exhaust stream. Generally, this type of sensor comprises a pair of current pumping electrodes, wherein both are in contact with an oxide conductive solid electrolyte and one electrode is in contact with a gas diffusion-limiting medium. The gas diffusion-limiting medium in conjunction with the pump electrode creates a limiting current, which is linearly proportional to the measured gas concentration in the sample. However, the current produced by the cell can differ with respect to oxygen consuming and oxygen donating test gases. For example, when NOx gases are sensed, nitric oxide (NO) and nitrous oxide (N₂O) can consume oxygen from the grain boundaries (the surfaces where the electrodes and sensor contact the electrolyte) of the cell, thereby generating a generally negative electrical current. Conversely, nitrogen dioxide (NO₂) releases oxygen to the grain boundaries, and thereby can generate a generally positive electrical current. The negative signal produced by the nitric oxide (NO) and nitrous oxide (N₂O) decreases the positive signal produced by the nitrogen dioxide (NO₂). Therefore, the measured NOₓ concentration within a test gas estimated by the resulting current. This estimation can be challenging to correct by gas sensor designers because the concentrations of the individual components of NO, N₂O and NO₂ are unknown. Therefore, increased gas sensor accuracy can be achieved if the NOx gases present in the exhaust stream are either oxygen consumers (NO and N₂O ) or an oxygen donor (NO₂), but not both.

What is needed in the art is a sensor that is cable of measuring an ammonia concentration and/or NO_{X} concentration of an exhaust gas.

### SUMMARY

Disclosed herein are catalytic coatings, methods for manufacturing catalytic coatings, gas sensors, and methods for treating exhaust gas.

In one embodiment, a gas sensor element comprises: an electrolyte disposed between and in ionic communication with a first electrode and a second electrode; and a protective layer disposed adjacent to the first electrode. The protective layer comprises a catalytic coating comprising a reducible support material, a catalyst, and a water activator material. The catalyst coating is capable of converting an oxygen consuming species in a gas to an oxygen donating species.

In one embodiment, a method of making a sensor element comprises: contacting a gas sensor element with the gas stream, converting oxygen consuming species in the gas to oxygen donating species to form a converted gas, contacting the first electrode with the converted gas, and measuring a concentration of NOx in the gas stream.

The above described and other features will be appreciated and understood from the following detailed description, drawings, and appended claims.

### BRIEF DESCRIPTION OF THE DRAWINGS

Refer now to the figures, which are exemplary embodiments, and wherein the like elements are numbered alike.

FIG. 1 is an exploded view of an exemplary planar sensor element.

FIG. 2 is a cross-sectional top view of an exemplary reducible support particle with catalyst particles and water activator material particles disposed thereon.

### DETAILED DESCRIPTION

This disclosure relates to gas sensors that employ catalytic coating(s) capable of converting oxygen consuming gases into oxygen donating gases to allow for improved measurement accuracy. The catalytic coating, that can be disposed on an outer surface of the sensor element such that the gas to be sensed passes through the catalytic coating prior to contacting a sensing electrode, comprises a reducible support material with catalyst and water activator material disposed thereon. While described in relation to a planar sensor element having a single electrochemical cell, it is to be understood that various geometries may be employed and that multiple electrochemical cells may be employed.

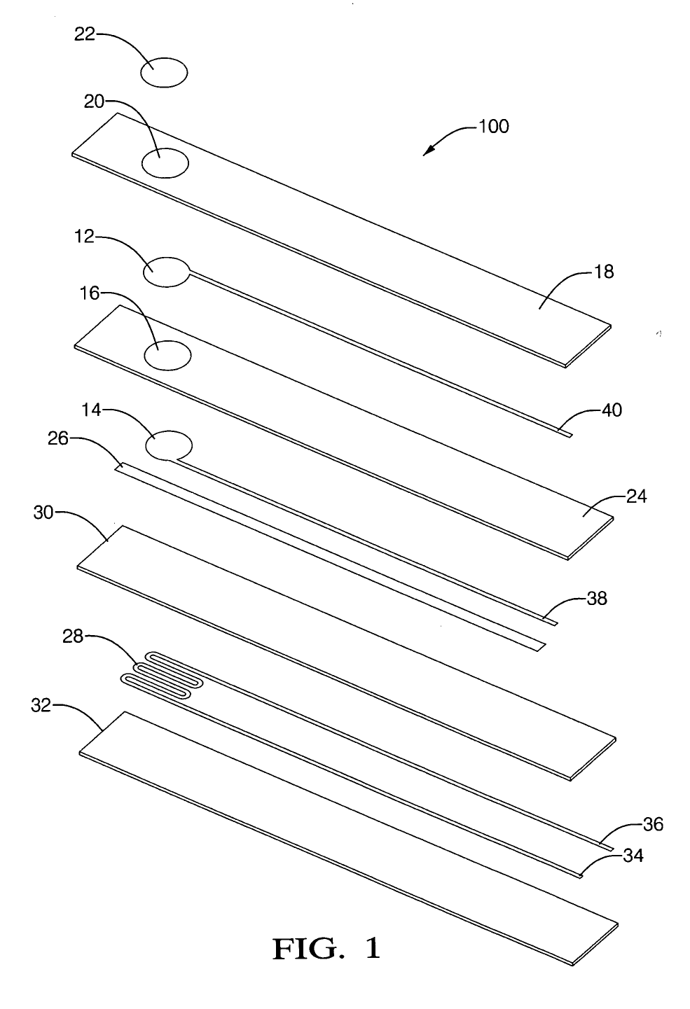

Referring to FIG. 1, an isometric view of an exemplary sensor element, generally designated 100, is illustrated. In the illustration, a sensing (i.e., first, exhaust gas, or outer) electrode 12 and a reference (i.e., second, reference gas, or inner) electrode 14 are disposed on opposite sides of, and adjacent to, an electrolyte 16, where combined form an electrochemical cell (12/16/14). On the side of the sensing electrode 12 opposite the electrolyte 16 is a protective layer 18 comprising a porous section 20 that enables fluid communication between the sensing electrode 12 and an exhaust gas. A catalytic coating 22 is disposed over the porous section 20. The electrolyte 16 and the porous section 20 can be disposed adjacent to, or inserts within, support layer 24 and protective layer 18, respectively. Meanwhile, disposed on a side of the reference electrode 14, opposite electrolyte 16, can be an optional reference gas channel 26, which is in fluid communication with the reference electrode 14 and optionally with the ambient atmosphere and/or the exhaust gas. Disposed on a side of the reference gas channel 26, opposite the reference electrode 14 may optionally be a heater 28 for maintaining sensor element 100 at a desired operating temperature. Disposed between the reference gas channel 26 and the heater 28, as well as on a side of the heater opposite the reference gas channel 26, can be one or more insulating/support layers 30, 32.

In addition to the above described sensor components, other sensor components can be employed, including lead gettering layer(s), leads (34, 36, 38, 40), contact pads, a ground plane, ground plane layers(s), support layer(s), additional electrochemical cell(s), and so forth. The leads, which supply current to the heater 28 and electrodes (e.g., sensing electrode 12 and reference electrode 14), are often formed on the same layers as the heater and the electrodes to which they are in electrical communication, and can extend from the heater/electrode to a terminal end of the sensor element.

Sensor element 100 can be disposed within a protective casing (not shown) having holes, slits and/or apertures, which act to generally limit the overall exhaust gas flow contacting sensor element 100. This arrangement extends the useful life of sensor element 100 by minimizing the ion transport through the electrodes 12,14 and electrolyte 16. Furthermore, any shape can be used for the sensor element 100, including conical, tubular, rectangular, and flat, and so forth, and the various components, therefore, can have complementary shapes, such as circular, oval, quadrilateral, rectangular, or polygonal, among others.

The electrodes 12, 14 are disposed in ionic communication with the electrolyte 16. The sensing electrode 12, which is exposed to the exhaust gas during operation, preferably has a porosity sufficient to permit diffusion of oxygen molecules therethrough. Similarly, the reference electrode 14, which can be exposed to a reference gas such as oxygen, air, or the like, during operation, preferably has a porosity sufficient to permit diffusion of oxygen molecules therethrough. The electrodes 12, 14 can comprise any catalyst material capable of ionizing oxygen, including materials such as platinum, palladium, osmium, rhodium, iridium, gold, ruthenium, and so forth, as well as oxides, mixtures, and alloys comprising at least one of the foregoing catalysts, with other materials also possibly present, such as zirconium, yttrium, cerium, calcium, aluminum, silicon, and so forth. The electrodes 12, 14 can be formed by various techniques, including sputtering, painting, chemical vapor deposition, screen-printing, stenciling, and so forth. Electrode leads 38 and 40 are generally formed simultaneously with electrodes 12, 14, and can comprise the same materials as electrodes 12, 14.

The electrolyte 16 can be solid or porous, can comprise the entire layer (e.g., support layer 24) or a portion thereof, and can comprise any material that is capable of permitting the electrochemical transfer of oxygen ions therethrough. Furthermore, electrolyte 16 can comprise a material that is compatible with the environment in which the gas sensor is utilized (e.g., 1,000° C.). Possible electrolyte 16 materials include zirconium oxide (zirconia), cerium oxide (ceria), calcium oxide, yttrium oxide (yttria), lanthanum oxide, magnesium oxide, and so forth, as well as combinations comprising at least one of the foregoing electrolyte materials, such as yttria doped zirconia, and the like. The electrolyte 16 can be formed using those methods discussed above with regard to electrodes 12, 14. It should further be noted that any shape can be used for the electrolyte 16. However, electrolyte 16 can comprise a geometry that is generally compatible with the electrode(s) such that sufficient exhaust gas access to the electrode(s) is enabled and sufficient ionic transfer through the electrolyte 16 is established.

Insulating/support layers 30, 32, and protective layer 18, provide structural integrity (e.g., protect various portions of the gas sensor from abrasion and/or vibration, and so forth, and provide physical strength to the sensor), and physically separate and electrically isolate various components. These layer(s), which can be formed using ceramic tape casting methods or other methods such as plasma spray deposition techniques, screen printing, stenciling, and so forth, can each have a thickness of less than or equal to about 200 micrometers (μm), or more specifically, about 5 μm to about 150 μm, or even more specifically, about 10 μm to about 100 μm. Since the materials employed in the manufacture of sensor element 100 can comprise substantially similar coefficients of thermal expansion, shrinkage characteristics, and chemical compatibility in order to minimize, if not eliminate, delamination, warpage, and other processing problems, the particular material for the insulating and protective layers is dependent upon the specific electrolyte employed. Generally, these layers comprise a dielectric material such as alumina (such as, delta alumina, gamma alumina, theta alumina, and the like, as well as combinations comprising at least one of the foregoing), and so forth.

Disposed between the insulating layers 30, 32, is a heater 28, which is employed to maintain the sensor element 100 at the desired operating temperature. More particularly, heater 28 is capable of maintaining an end of the sensor element 100 that comprises the electrodes 12, 14 at a sufficient temperature to facilitate the various electrochemical reactions therein, with an operating temperature of about 650° C. to about 800° C., or more specifically, about 700° C. to about 750° C. Heater 28, which can comprise, for example, platinum, aluminum, palladium, and so forth, as well as mixtures, oxides, and alloys comprising at least one of the foregoing metals can be screen printed or otherwise disposed onto a substrate (e.g., insulating layers 30, 32), to a thickness sufficient for the heater 28 to bring the sensor element 100 up to the desired operating temperature. For example, a thickness of about 5 micrometers to about 50 micrometers can be employed.

Disposed on at least the outer surface of the protective layer 18 is a catalytic coating 22. The catalytic coating 22 is disposed over a porous section 20 of protective layer 18 such that the catalytic coating 22 is in ionic communication with electrode 12. The catalytic coating 22 is capable of efficiently converting ammonia (NH₃) into nitrogen dioxide (NO₂), is capable of efficiently converting nitrogen oxide (NO) into NO₂, is capable of efficiently converting nitrous oxide (N₂O) to NO₂, is capable of efficiently converting carbon monoxide (CO) into carbon dioxide (CO₂), wherein efficiently converting a given species is defined as converting greater than or equal to 80 vol. % of the given species passing through the catalytic coating 22, however converting greater than or equal to 90 vol. % can yield more accurate gas measurements.

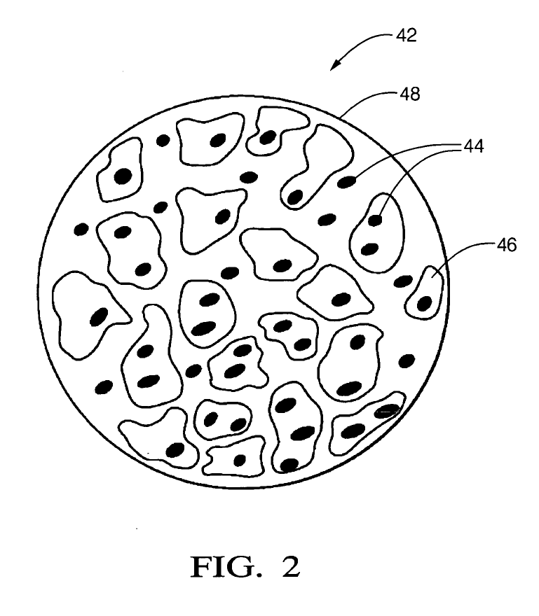

Referring now to FIG. 2, a cross-sectional top view of an exemplary reducible support particle 48 comprising a catalyst 44 disposed over the reducible support material 48, and a water activator material 46 disposed over the catalyst 44, collectively designated 42. The catalytic coating 22 comprises a plurality of reducible support particles 48, which will be discussed further below.

The reducible support material 48 can comprise a sufficient size and surface area to support the catalyst 44 and the water activator material 48. For example, the particles can have a surface area of greater than or equal to about 160 m²/g at temperatures of up to about 600° C. The reducible support material 48 can also have an average particle size, as measured along a major axis, less than or equal to about 10 μm, or, more specifically, about 0.01 μm to about 5.0 μm, or, even more specifically, about 0.05 μm to about 0.5 μm.

The reducible support material 48 preferably comprises a porous (e.g., microporous) nanocrystalline material, such as, but not limited to, titanium suboxides, gallium suboxides, tin suboxides, silicon suboxides, as well as combinations comprising at least one of the foregoing. In an exemplary embodiment, the reducible support material 48 can comprise titanium oxide, which can inhibit sulfur from blocking the catalyst 44 from communicating with the exhaust stream at temperatures below about 275° C. The catalyst 44 can be capable of converting oxygen consuming gases (e.g., NO, N₂O) into oxygen donating gases (NO₂). Further, the catalyst 44 can be deposited upon the support material 48 while the reducible support material 48 is in a reduced oxidation state, for example, one of the titanium suboxides (e.g., Ti₄O₇, Ti₃O₅, Ti₂O₃,TiO, as well as combinations comprising at least one of the foregoing).

Suitable titanium compounds that can be employed for the reducible support material 48 can include titanium oxalate, titanium ethoxide, titanium methoxide, titanium isopropoxide, titanium n-butoxide, and so forth, as well as combinations comprising at least one of the foregoing, with titanium isopropoxide preferred.

Suitable trialkyl tin compounds that can be employed as a precursor to a reducible support include, for example, trimethyl tin hydroxide, tributyl tin hydroxide, trioctyl tin hydroxide, and so forth, as well as combinations comprising at least one of the foregoing. In addition, tetraalkyl tin compounds can be employed, such as, but not limited to, tetramethyl tin (SnMe₄), tetraethyl tin, tetra-n-butyl tin, tetra-n-octyl tin, and so forth. Other exemplary compounds that can be employed include carboxylic acid type organometallic tin compounds such as (C₄H₉)₂Sn(OCOC₁₁H₂₃)₂; mercaptide type organometallic tin compounds such as (C₄H₉)₂Sn(SCH₂COOC₈H₁₇)₂; sulfide type organometallic tin compounds such as (C₄H₉)₂Sn═S; organometallic tin oxides such as (C₄H₉)2SnO; and chloride type organometallic tin compounds such as (C₄H₉)₂SnC₁₃.

Not to be bound by theory, it is believed that, in this exemplary configuration, there can be an interaction between the catalyst 44 and the oxygen deficient suboxide-based reducible support material 48, which can inhibit the migration and growth of the catalyst material 44. For example, a platinum-based catalyst material 44 can penetrate the intracrystalline crystal lattice of a titanium oxide-based reducible support material 48, which can inhibit migration and catalyst growth. This can even hold true when the suboxide-based reducible support material 48 comprises titanium monoxide (Ti⁺²) that is partially oxidized (Ti⁺³), or fully oxidized into titanium dioxide (Ti⁺⁴), in these examples the high initial dispersion of the catalyst material is maintained.

The water activator material 46 can be deposited over the reducible support material 48, and the catalyst 44, to promote water absorption and thusly the interaction between the reducible support material 48 and the catalyst 44, such that the NOx and ammonia (NH₃) oxidation activity is not diminished. Desirably, the water activator material 46 forms a layer on at least the catalyst 44. The activator layer can have a thickness equal to or less than about 10 nanometers (nm), or more specifically about 0.01 nm to about 5 nm, or even more specifically, about 0.1 to about 2 nm. Further, it is noted that the combined effect of the catalyst 44 and the reducible support material 48 can advantageously be used to dehydrogenate water in an exhaust stream to form hydroxyl, which can be beneficial for the oxidative removal of carbon monoxide. For example, a layer of ZrO₂ comprising a thickness of about 8 nm can be deposited over titanium suboxide particles using the soluble zirconium precursor zirconium ethoxide. The resultant material can then be calcined. Once formed, the water activator material 46 (e.g., the zirconium oxide) can be present in the catalytic coating 22 in an amount of equal to or greater than about 0.2 weight percent (wt. %), or more specifically about 0.5 wt. % to about 2 wt %, or even more specifically, about 0.8 wt % to about 1.6 wt. %, based upon a total weight of the catalytic coating 22.

Suitable zirconium compounds that can be employed as the water activator material comprise zirconium ethoxide, zirconium oxychloride, zirconium tert-butoxide, zirconium isopropoxide, colloidal zirconium oxide, zirconium dioxide, and so forth, as well as combinations comprising at least one of the foregoing.

The catalyst 44 can comprise precious metals, such as, platinum (Pt), palladium (Pd), rhodium (Rh), iridium (Ir), ruthenium (Ru), gold (Au), silver (Ag), and so forth, as well as combinations comprising at least one of the foregoing, including bimetallics such as gold-platinum (AuPt), ruthenium-platinum (RuPt), and so forth. The catalyst materials can have an average particle size, measured along the major axis (i.e., the longest axis), of less than or equal to about 25 nm, or more specifically, about 0.1 to about 10 nm, and even more specifically equal to about 2 to about 5 nm.

The catalyst 44 can be deposited onto a surface of the reducible support material 48 (e.g. titanium suboxide related structure (e.g., Ti₄O₇, Ti₃O₅, Ti₂O₃ or TiO)). For example, an organometallic precursor comprising the precious metal and an organic component may first be formed. Possible materials for the organic component of the organometallic precursor include napthalenes, tallates, neodecanates, isopropoxides, carboxylic acids and their esters, carboxylates, alkoxycarboxylates, phthalates, alcohols such 2-methoxyethanol, guanidine, fatty acids, and combinations comprising at least one of the foregoing metals. Possible carboxylic acids include stearic, oleic, linolenic, hexanoic, octanoic, neodecanoic, and so forth, as well as their respective esters. In addition, acetylacetonates, such as platinum (II) acetylacetonate, can be used to deposit the catalyst material on the reducible support material 48.

In one embodiment, the catalyst 44 (e.g., precious metals) can be deposited onto a suboxide reducible support material 48 (e.g., TiO) using organometallics such as ruthenium 2-ethylhexanoate and/or ruthenium neodecanoate in an organic solution. It is noted that ruthenium 2-ethylhexanoate and ruthenium neodecanoate may be used as a carrier to deposit a quantity of ruthenium metal. In other words, the organic component of the organometallic precursor decomposes, leaving the precious metal disposed on the support material. More particularly, the organic component of the organometallic precursor may be decomposed when the sensing element 100 is fired.

The organometallic precursor can be washcoated, imbibed, impregnated, physisorbed, chemisorbed, precipitated, or otherwise applied to the support material. In other embodiments, the organometallic precursor can be mixed with the support material, and can then be washcoated, imbibed, impregnated, physisorbed, chemisorbed, precipitated, or otherwise applied to a surface of protective layer 18, more particularly the porous section 20 of the protective layer 18 in a single step.

The formation of large precious metal particles due to interactions with anions (e.g., chlorine) can be limited by using hydrogen donors (e.g., ammonia) and/or organic solvents (e.g., ethanol) for deposition of the catalyst 44. Alternatively, the catalyst 44 can be deposited from an organometallic, such as silver neodecanoate. Further, the catalytic coating 22 can comprise a sufficient catalyst loading to convert the desired species (e.g., the ammonia (NH₃), nitric oxide (NO), nitrous oxide (N₂O), and/or carbon monoxide (CO)) that passes through the catalytic coating 22 to nitrogen dioxide (N₂O), as discussed above. For example, the catalytic coating can have a precious metal loading of less than or equal to about 5.0 wt. %, or, more particularly, less than or equal to about 2 wt % of the particle in FIG. 2

Furthermore, a catalytic coating 22 can comprise layer(s) having an overall thickness of less than or equal to about 200 μm, or more specifically, a thickness of about 50 μm to about 150 μm. The porosity of the catalytic coating 22 can be tailored depending on the environment of use, test gas composition, and so forth. This porosity (i.e., void volume), can be sufficient to enable the passage of the desired gases and facilitate contact of the oxygen consuming species with the water activator material. For example, the catalytic coating 22 can have a porosity of about 1 volume percent (vol %) to about 35 vol %, or more specifically, about 1 vol % to about 20 vol %, or, even more specifically, about 5 vol % to about 15 vol %, or even more specifically, about 7 vol % to about 14 vol %, based upon a total volume of the catalytic coating 22. The pores throughout catalytic coating 22 (e.g. the pores created by particle packing voids that the exhaust gasses transport through), can have an average pore size of equal to or less than 2.5 μm, or more specifically, equal to or less than 1.0 μm, or even more specifically, equal to about 0.08 μm to about 0.2 μm.

The catalytic coating 22 can be applied to the sensor employing any method. Some possible techniques include imbibing, spraying, spray coating, impregnating, painting, dipping, spin coating, vapor deposition, and so forth. For example, a solution, suspension, ink, paste, slurry, or other type of mixture is prepared by mixing discrete particles of reducible support material 48, catalyst 44, and water activator material 46 with a solvent and a binder in amounts sufficient to attain the desired slurry viscosity. Some possible solvents include water, ethanol, methanol, butanol, benzoic acid, acetic acid, citric acid, or the like, as well as combinations comprising at least one of the foregoing. The mixture can comprise a sufficient amount of discrete particles to attain the desired loading in a single process step (e.g. a single dip in a dip-coating process). Generally, a slurry comprising equal to or greater than about 45 wt. % solids, balanced with solvent, can be employed, wherein the solids includes the discrete particles of reducible support material 48, catalyst 44, water activator material 46, and an optional binder. To be more specific, a slurry can be formulated to comprise equal to or greater than about 50 wt. % solids, or even more specifically, about 52 wt. % to about 54 wt. % solids of the total slurry weight. Alternatively, if multiple applications (e.g., layers) are employed, a catalytic coating 22 can comprise a lower solids concentration, such as equal to or less then 45 wt. % solids, or even more specifically, equal to or less than 35 wt. % solids, or even more specifically, equal to or less than 25 wt. % solids of the total slurry weight.

In one embodiment, a slurry can be mixed with a high shear mixing apparatus, wherein the slurry comprises a gold-platinum (AuPt) catalyst 44 that is deposited on both coarse TiO and fine TiO reducible support material 48 particles; a zirconia (ZrO₂) water activator material 46 that can be deposited on both the coarse AuPt/TiO particles and fine AuPt/TiO particles. Once the slurry comprises a desired viscosity, it can be applied to the desired area of the sensor. Typically the catalytic coating 22 is applied to the protective layer (20) (see FIG. 1). The coated sensor element 100 can then be calcined (e.g., about 850° C.).

Prior to forming the slurry, the reducible support material 48 particles can be milled (e.g., wet, dry) to refine particle size and/or reduce agglomeration.

The slurry may also contain fugitive materials, such as dissolved organics and so forth, that can occupy space until the catalytic coating is fired, thus leaving porosity in the catalytic coating 22. Suitable fugitive materials are accordingly those that can release at firing temperatures, and include, but are not limited to, carbon based materials, such as carbon black, graphite, non-dissolved organics, and so forth, as well as combinations comprising at least one of the foregoing materials. Fugitive materials can be incorporated in any amount and having any size to the catalytic coating precursor to provide a desired porosity. In one example, a slurry can comprise carbon black, which can comprise a particle size, measured along a major axis, of about 0.02 μm to about 0.2 μm, which yields a catalytic coating 22 having sufficient porosity to enable the passage of exhaust gases there through and pore sizes small enough to inhibit the transmission of poisoning particulates (e.g., soot).

Fugitive materials can also comprise acrylic binders, polyvinyl alcohol, 1-ethoxypropan-2-ol, turpentine, squeegee medium, 1-methoxy-2-propanol acetate, butyl acetate, dibutyl phthalate, fatty acids, acrylic resin, ethyl cellulose, 3-hydroxy,2,2,4-trimethylpentyl isobutyrate, terpineol, butyl carbitol acetate, cetyl alcohol, cellulose ethylether resin, and so forth, as well as combinations comprising at least one of the foregoing. For example, a slurry may comprise 1.4 wt % butylacetate, 4.0 wt % dibutyl phthalate, 2.9 wt % ethyl cellulose, 8.0 wt % terpineol and 0.6 wt % butyl carbitol acetate.

In another embodiment of a catalytic coating 22, the coating can comprise about 88 weight percent (wt. %) to about 98 wt. % reducible support material, about 1 to about 12 wt. % water activator material 46, and about 1 to about 3 wt. % catalyst.

Advantageously, the sensor disclosed herein may be used to sense ammonia and/or NOx. For example, a sensor comprising a sensing element having a catalytic coating as described above may be position in an exhaust stream such that the sensor is downstream of a selective catalytic reduction (SCR) catalyst to measure NH₃ slip from the SCR catalyst. Alternatively, the sensor may be positioned upstream and/or downstream of a NOx adsorber to measure the NOx concentration in the exhaust gas. In other words, this sensor may be used as a NOx sensor or as an ammonia sensor.

It is noted that a NOx adsorber and SCR catalyst may be used as a part of a NOx abatement system. For example, NOx may be trapped e.g., stored on the NOx adsorber during lean operating conditions, i.e., when the air-to-fuel ratio is greater than the balanced combustion stoichiometry. For example, the air-to-fuel ratio is greater than about 14.7, and may generally be between about 19 to about 35. The system can be periodically operated under fuel-rich combustion to regenerate the NOx adsorber and/or a reducing agent (e.g., hydrogen, urea, ammonia, and so forth) may be introduced into the NOx adsorber to regenerate the NOx adsorber.

With regard to the SCR catalyst, it is noted that NH₃ may be stored/trapped in the SCR catalyst. NOx in the exhaust stream can react with NH₃ stored in the SCR catalyst to form the reaction products nitrogen and water. Periodically, the SCR catalyst may be regenerated during rich operation and/or by introducing ammonia into the SCR catalyst. As noted above, the NOx/NH₃ sensor may be positioned upstream/downstream of a NOx to sense the NOx concentration in the exhaust gas. This information may then be feedback to an on-board diagnostic system (e.g., a computer) to determine when the NOx adsorber is to be regenerated. Similarly, the NOx/NH₃ sensor may be positioned downstream of an SCR catalyst to sense ammonia slip from the SCR catalyst.

At exhaust gas temperatures above about 300° C. and below about 900° C., diesel exhaust NOx can comprise an equilibrium mixture of nitric oxide (NO) and nitrous dioxide (NO₂) and a higher concentration of nitrogen oxide (NO). In systems that comprise such a NOx composition, nitrogen oxide (NO) can react with oxygen to form nitrous oxide (NO₂) and nitrogen dioxide (NO₂) can release oxygen thereby decompose into NO.

The sensor element 100 comprises a catalytic coating 22 that is capable of converting oxygen consumers (e.g., NH₃, NO, N₂O) into oxygen donors (e.g., NO₂). This conversion of the oxygen consumers results in a sensing element 100 being able to measure a positive current on the converted and non-converted NO₂. This can result in an improved accuracy of NOx measurement as more NOx is accounted for in the actual measurement, or described another way, if at least a portion of the oxygen consuming species of NOx can be converted to nitrous oxide (NO₂), then the oxygen consuming species converted cannot generate a negative current that will offset the positive current produced by the oxygen donating species of NOx.

In addition, it is further noted that the ability of the sensor element 100 to measure oxygen donating species (e.g., NO₂)is improved in the absence of carbon monoxide (CO) for the reason that carbon monoxide is also an oxygen consumer. Therefore, it is also desirable the catalytic coating 22 and/or the porous section 20 can also convert carbon monoxide (CO) to carbon dioxide (CO₂).

The sensing element 100 and catalytic coating 22 are exemplified in the following examples which are illustrative and not limiting.

### EXAMPLES

### Example I

Preparation of particles; preparation of reducible support material 48: a reducible support material 48 comprising agglomerates of TiO₂ nanophase primary particles was prepared using water and titanium tetra-isopropoxide. The fine TiO₂ agglomerates, having a mean particle diameter of about 0.1 microns, were collected by filtration. The collected TiO₂ agglomerates were coated with amorphous carbon and annealed at 800° C. for 2 hours in a 3.0 vol. % hydrogen balance nitrogen atmosphere (3 vol. % hydrogen-nitrogen), which formed the desired nanophase TiO.

Preparation of particles; deposition of catalyst 44: The catalyst 44 was deposited on the reducible support material 48 using a solution of 4.1 g of 30 wt. % HAuCl₄.3H₂O catalyst material (weight average molecular weight of 339.81, 57.97 wt % Au) that was added dropwise to a vessel containing 82.0 grams TiO, and stirred for 1 hour at room temperature. Subsequently, a solution of 31.0 grams of aqueous ammonia was added dropwise to the stirred TiO and HAuCl₄.3H₂O mixture. The catalyst 44/reducible support material 48 was collected by filtration, dried at 90° C. in air overnight, heated to 650° C. in 3 vol. % hydrogen-nitrogen for 4 hours, and cooled to room temperature. The resulting powder contained about 1.5 wt. % gold deposited upon titanium monoxide.

Preparation of particles; deposition of water activator material 46: A water activator material 46 was deposited on the catalyst 44/reducible support material 48. A slurry of 75.0 grams Au—TiO and 75.0 grams H₂O was placed in a vessel. 12.7 grams zirconium n-propoxide (70 wt. % in isopropanol) dissolved in 35.0 grams isopropanol at a pH of 0.5, (isopropanol:HNO₃ mole ratio of 1:0.07) was added dropwise to the vessel while stirring the mixture at 500 RPM. After completion of the dropwise addition, the resulting mixture was stirred for 2 hours at 500 rpm. The catalytic coating agglomerates 42 were evacuated to dryness, filtered under vacuum, dried at 90° C. overnight and calcined at 800° C. in air for 2 hours. The resulting powder contained 85.0 grams zirconium-gold-titanium, ZrO₂—Au—TiO₂ (10.5 wt. % zirconium, 1.5 wt. % gold, 88.0 wt. % titanium).

Deposition of slurry upon sensor element 100: The catalytic coating agglomerates 42 were deposited on the sensor element 100 by formulating a slurry comprising 82.0 grams of the catalytic coating agglomerates 42 in 82 grams water, wherein the pH is adjusted to 9.0 by the addition of 2.3 grams of 25 wt. % aqueous solution of tetramethylammonium hydroxide (TMAOH). The mixture was mixed with a high shear mixer at 3,000 rpm for 20 minutes. Once the slurry, having the desired viscosity and composition was prepared, the sensor elements 100 were dipped into the slurry. The trapped air in the porous coatings was removed by placing the NOx sensors in a vacuum atmosphere for 3 minutes. The sensor elements were dried, then calcined at 500° C. for 1 hour, and further sintered at a temperature of 950° C. for 4 hours.

### Example II

Preparation of particles: preparation of reducible SnO₂ support material 30. Agglomerates of nanophase primary particles of SnO₂ were prepared through the interaction of t-butanol and tin tetrachloride. The fine SnO₂ agglomerates, having a mean particle diameter of less than 0.1 micrometers, were collected by ultracentrifuge and decantation/filtration. The SnO₂ particles were dried using a 70:30 mixture of n-butanol and xylene. Reduction of SnO₂ into SnO included collecting the SnO₂ agglomerates and then coating the collected agglomerates with carbon vapor generated by vaporization of amorphous carbon. The carbon coated tin oxide particles were annealed at 600° C. for 7 hours in a 4 vol. % hydrogen balance nitrogen atmosphere forming the desired nanophase SnO.

Preparation of impregnated SnO particles and deposition of Au catalyst material 26: A solution of 3.4 g of 30 wt. % HAuCl₄.3H₂O catalyst material (weight average molecular weight of 339.81, 57.97 wt % Au) was dropwise added to a vessel containing 68.0 grams SnO, and stirred for 6.5 hours at 75° C. Subsequently, 27.0 grams concentrated aqueous ammonia was dropwise added to the stirred SnO and HAuCl₄.3H₂O mixture. The catalyst material-support material was collected by ultracentrifuge, decantation and ultrafiltration, then dried at 110° C. in air overnight. It was then heated to 650° C. in 4 vol. % hydrogen-nitrogen for 7 hours, and then cooled to room temperature. The resulting powder contained 1.5 wt. % gold, Au, deposited upon tin monoxide, SnO.

Preparation of Au/SnO particles: deposition of ZrO₂ water activator material 28. A slurry of 57.0 grams Au—TiO and 75.0 grams H₂O was placed in a 1 liter (L) stainless steel vessel. 10.3 grams zirconium n-propoxide (70 wt. % in isopropanol) dissolved in 29.0 grams isopropanol at pH 0.5, (isopropanol:HNO₃ mole ratio equaling 1:0.07) was dropwise added to the 1 L stainless steel vessel while stirring the mixture at 500 rpm. After completion of the dropwise addition, the resulting mixture was stirred for 5.2 hours at 400 rpm. The catalyst material(Au)-support material(SnO) was subsequently evacuated to dryness, filtered under vacuum, dried at 135° C. overnight. After affixing the catalyst material(Au)-tin monoxide SnO was calcined at 740° C. in air for 1 hour. The resulting powder contained 85.0 grams zirconium-gold-tin, ZrO₂—Au—SnO (10.5 wt. % zirconium, 1.5 wt. % gold, 88.0 wt. % tin).

Deposition of slurry upon sensor element 100: The 85.0 grams of ZrO₂—Au—SnO particles were then slurried in 82 grams water and the pH was adjusted to 11.4 by the addition of 4.1 grams of a 25 wt. % aqueous solution of tetramethylammonium hydroxide (TMAOH). The mixture was mixed with a high shear mixer at 3000 RPM for 20 minutes. Once the slurry having the desired viscosity and composition was prepared, the slurry was applied to the desired area of the sensor. NO₂ measuring sensors comprising insulating/support layers 30, 32, measuring electrode 12 and protective layer 18 were dipped into the ZrO₂—Au—SnO slurry. The trapped air in the porous coatings was removed by placing the NOx sensors in a vacuum atmosphere for 3 minutes. The NO₂ sensors were dried, then calcined at 500° C. for 1 hour and further sintered at a temperature of 750° C. for 4 hours. The coating of the sensors was substantially free of surface imperfections.

### Example III

Preparation of BaY-zeolite support material 30: Agglomerates of particles of BaY-zeolite were prepared through the ion exchange of barium ions for sodium ions through the reaction of barium nitrate and sodium Y-zeolite. Three hundred and forty grams of sodium Y-zeolite powder having mean particle diameter of 0.3 micrometers, was mixed with 409 grams barium nitrate and 1.6 liters of water. The slurry mixture was heated to 58° C. for 4 hours and then separated by ultracentrifuge, decanted and filtered. The powder was rinsed with 1 liter water, then again separated by ultracentrifuge, decanted and filtered. Three successive ion exchanges and rinses were used to fully exchange all the sodium ions with barium ions. The filtered powder was calcined at 650° C. in air for 7 hours, and then cooled to room temperature. The calcined BaY-zeolite powder contained 18.5 wt. % barium, Ba, deposited upon the sodium sites of the Y-zeolite.

Deposition of Au catalyst material 26: A solution of 15.0 grams of 30 wt. % HAuCl₄.3H₂O catalyst material (mol wt 339.81, 57.97 wt % Au) was dropwise added to a vessel containing 280.0 grams BaY-zeolite and 450 grams water. The mixture was stirred for 2.5 hours at 60° C. temperature. Subsequently, 160.0 grams concentrated aqueous ammonia was dropwise added to the stirred BaY-zeolite and HAuCl₄.3H₂O mixture. The catalyst material (HAuCl₄.3H2O)-support material (BaY-zeolite) was collected by filtration, then dried overnight at 110° C. under a vacuum atmosphere. The dried powder was heated to 650° C. in 4 vol. % hydrogen-nitrogen atmosphere for 7 hours, and then cooled to room temperature. The calcined Au/BaY-zeolite powder contained 1.5 wt. % gold, deposited upon BaY-zeolite.

Deposition of ZrO₂ water activator material 28: A slurry of 260.0 grams Au/BaY-zeolite was placed in a 2 L stainless steel vessel. 81.3 grams zirconium n-propoxide (70 wt. % in isopropanol) dissolved in 600.0 grams isopropanol at a pH of 0.5, (isopropanol:HNO₃ mole ratio of 1:0.07) was dropwise added to the 2 L stainless steel vessel while stirring the mixture at 800 rpm. After completion of the dropwise addition, the resulting mixture was stirred for 0.8 hours at 400 rpm. The encapsulating water activator material (ZrO₂)-catalyst material (Au)-support material (BaY-zeolite) was subsequently filtered under vacuum, dried under vacuum at 135° C. overnight. The resulting ZrO₂ encapsulated Au/BaY-zeolite powder was calcined at 740° C. in air for 3.0 hours. The resulting ZrO₂—Au—Y-zeolite powder contained 10.5 wt. % zirconium oxide, 1.5 wt. % gold and 88.0 wt. % Y-zeolite.

Deposition of slurry upon NOx sensor element 100: Eighty five grams of ZrO₂—Au—Y-zeolite particles were then slurried in 108 grams water and the pH was adjusted to 11.4 by the addition of 5.0 grams of a 25 wt. % aqueous solution of tetramethylammonium hydroxide (TMAOH). The mixture was mixed with a high shear mixer at 3,000 rpm for 20 minutes. Once the slurry having the desired viscosity and composition was prepared, the slurry was applied to the desired area of the sensor. NO₂ measuring sensors comprising insulating/support layers 30, 32, measuring electrode 12 and protective layer 18 were dipped into the ZrO₂—Au—Y-zeolite slurry. The trapped air in the porous coatings was removed by placing the NOx sensors in a vacuum atmosphere for 3 minutes. The NO₂ sensors were dried, then calcined at 500° C. for 1 hour and further sintered at a temperature of 750° C. for 4 hours. The coating of the sensors was substantially free of surface imperfections.

### Example IV

Deposition of Pt catalyst material 26: An isopropanol solution of hexachloroplatinic acid H₂Pt(Cl)₆ catalyst material was dropwise added to a vessel containing 300.0 grams NaY-zeolite (Si:Al ratio 2.4) and 450 grams water. The mixture was stirred for 2.5 hours at a temperature of 60° C. Subsequently, 205.0 grams concentrated aqueous ammonia was dropwise added to the stirred Y-zeolite-Pt(Cl)₆-isopropanol mixture. The mixture was concentrated by vacuum, then dried overnight at 85° C. under a vacuum atmosphere. The dried powder was collected and heated to 650° C. in flowing 4 vol. % hydrogen-nitrogen atmosphere air for 2.5 hours, and then cooled to room temperature. The calcined Pt/Y zeolite powder contained 0.45 wt. % platinum deposited upon a Y-zeolite.

Deposition of SnO₂ water activator material 28: A slurry of 260.0 grams Pt/Y-zeolite was placed in a 2 L stainless steel vessel under a nitrogen (N₂) atmosphere. One hundred and fifty three grams tin (IV) iso-propoxide at an 8.0 wt. % concentration in neat isopropanol was dropwise added to the 2 L stainless steel vessel while stirring the mixture at 800 revolution per minute (rpm). After completion of the dropwise addition, the resulting mixture was continuously stirred for 8 hours at 400 rpm. The isopropanol was slowly evaporated from the container over a 6-hour period aided by a water bath heated to 65° C. The residual Pt/Y-zeolite powder encapsulated with the SnO₂ layer was removed from the stainless container and dried in a vacuum oven at 135° C. overnight then calcined at 740° C. in air for 3.0 hours. The resulting SnO₂—Pt—Y zeolite powder contained 4.7 wt. % zirconium oxide, 0.45 wt. % platinum and 94.85.0 wt. % Y-zeolite (Si:Al ratio 2.8).

Deposition of slurry upon NOx sensor element 100: One hundred and thirty eight grams of SnO₂—Pt—Y-zeolite particles were slurried in 175 grams water and the pH was adjusted to 12.6 by the addition of 10 grams of a 25 wt. % aqueous solution of tetramethylammonium hydroxide (TMAOH). The mixture was mixed with a high shear mixer at 3,000 rpm for 20 minutes. NO₂ measuring sensors comprising insulating/support layers 30, 32, measuring electrode 12 and protective layer 18 were dipped into the SnO₂—Pt—Y-zeolite slurry. The trapped air in the porous coatings was removed by placing the NOx sensors in a vacuum atmosphere for 3 minutes. The NO₂ sensors were dried, then calcined at 500° C. for 1 hour and further sintered at a temperature of 750° C. for 4 hours.

The terms “first,” “second,” and the like herein do not denote any order or importance, but rather are used to distinguish one element from another, and the terms “a” and “an” herein do not denote a limitation of quantity, but rather denote the presence of at least one of the referenced items. Furthermore, all ranges are inclusive and independently combinable (e.g., ranges of “up to about 25 weight percent (wt. %), or, more specifically, about 5 wt. % to about 20 wt. %, are inclusive of the endpoints and all intermediate values of the ranges, e.g., about 5 wt. % to about 25 wt. %, etc.). The modifier “about” used in connection with a quantity is inclusive of the stated value and has the meaning dictated by the context (e.g., includes the degree of error associated with measurement of the particular quantity). Also, the terms “front”, “back”, “bottom”, and/or “top” are used herein, unless otherwise noted, merely for convenience of description, and are not limited to any one position or spatial orientation. The suffix “(s)” as used herein is intended to include both the singular and the plural of the term that it modifies, thereby including one or more of that term (e.g., the metal(s) includes one or more metals).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A gas sensor element, comprising:
an electrolyte disposed between and in ionic communication with a first electrode and a second electrode; and
a protective layer disposed adjacent to the first electrode, wherein the protective layer comprises a catalytic coating comprising a reducible support material, a catalyst, and a water activator material;
wherein the catalyst coating is capable of converting an oxygen consuming species in a gas to an oxygen donating species.

2. The gas sensor element of claim 1, wherein the oxygen consuming species is selected from the group consisting of ammonia, nitrogen oxide, nitrous oxide, carbon monoxide, and combinations comprising at least one of the foregoing.

3. The gas sensor element of claim 2, wherein the oxygen donating species is selected from the group consisting of nitrogen dioxide, carbon dioxide, and combinations comprising at least one of the foregoing.

4. The gas sensor element of claim 2, wherein the oxygen consuming species is selected from the group consisting of nitrogen oxide, nitrous oxide, and combinations comprising at least one of the foregoing.

5. The gas sensor element of claim 1, wherein the reducible support material comprises a nanocrystalline material.

6. The gas sensor element of claim 5, wherein the reducible support material is selected from the group consisting of titanium suboxides, gallium suboxides, tin suboxides, silicon suboxides, and combinations comprising at least one of the foregoing.

7. The gas sensor element of claim 5, wherein the reducible support material comprises a titanium suboxide selected from the group consisting of Ti₄O₇, Ti₃O₅, Ti₂O₃, TiO, and combinations comprising at least one of the foregoing.

8. The gas sensor element of claim 1, wherein the catalyst has a particle size, measured along a major axis, of less than or equal to about 25 nm.

9. The gas sensor element of claim 8, wherein the particle size is about 0.1 to about 10 mn.

10. The gas sensor element of claim 9, wherein the particle size is about 2 nm to about 5 nm.

11. The gas sensor element of claim 1, wherein the water activator material can be in the form of a layer on the catalyst having a thickness of less than or equal to about 10 nm.

12. The gas sensor element of claim 1, wherein the water activator material comprises a zirconium compound.

13. The gas sensor element of claim 12, wherein the zirconium compound is selected from the group consisting of zirconium ethoxide, zirconium oxychloride, zirconium tert-butoxide, zirconium isopropoxide, colloidal zirconium oxide, zirconium dioxide, as well as combinations comprising at least one of the foregoing.

14. The gas sensor element of claim 1, wherein the water activator material is present in the coating in an amount of about 0.5 wt. % to about 2 wt % , based upon a total weight of the coating.

15. The gas sensor element of claim 1, wherein the catalytic coating has a porosity of about 5 vol % to about 15 vol %, based upon a total volume of the catalyst coating.

16. The gas sensor of claim 15, wherein pores in the catalytic coating have an average size, measured along a major axis, of about 0.01 nm to about 10 nm.

17. The gas sensor element of claim 1, wherein the catalytic coating has a thickness of less than or equal to about 200 μm.

18. The gas sensor element of claim 1, wherein the a reducible support material comprises a titanium suboxide, the catalyst comprises gold, and the water activator material comprises a zirconium oxide.

19. A method of sensing NOx in a gas stream, comprising:
contacting a gas sensor element with the gas stream, wherein the gas sensor element comprises
an electrolyte disposed between and in ionic communication with a first electrode and a second electrode; and
a protective layer disposed adjacent to the first electrode, wherein the protective layer comprises a catalytic coating comprising a reducible support material, a catalyst, and a water activator material;
converting oxygen consuming species in the gas to oxygen donating species to form a converted gas;
contacting the first electrode with the converted gas; and
measuring a concentration of NOx in the gas stream.

20. The method of claim 19, wherein the a reducible support material comprises a titanium suboxide, the catalyst comprises gold, and the water activator material comprises a zirconium oxide.
